(19) United States
(12) Patent Application Publication
(10) Pub. No.: US 2018/0089854 A1
(43) Pub. Date: Mar. 29, 2018

(54) 3D TRANSPARENT DISPLAY DEVICE AND OPERATING METHOD THEREOF

(71) Applicant: Korea Electronics Technology Institute, Seongnam-si (KR)

(72) Inventors: Yang Keun AHN, Seoul (KR); Kwang Soon CHOI, Goyang-si (KR); Young Choong PARK, Goyang-si (KR)

(21) Appl. No.: 15/468,707

(22) Filed: Mar. 24, 2017

(30) Foreign Application Priority Data
Sep. 26, 2016 (KR) 10-2016-0122813

(51) Int. Cl. G06T 7/73; G06T 19/00

(52) U.S. Cl. CPC G06T 7/74; G06T 19/006; G06T 2207/30201; G06T 2207/20221; G06T 2207/10028

(57) ABSTRACT

A three-dimensional (3D) transparent display device is provided. The 3D transparent display device includes a position obtaining unit configured to obtain information regarding 3D positions of both eyes of a user and a 3D position of a real object; a controller configured to estimate a two-dimensional (2D) position on a display screen at which an image of a virtual object is to be displayed on the basis of the 3D positions of the both eyes of the user and the 3D position of the real object; and a 3D transparent display panel configured to display the image of the virtual object on the display screen on the basis of the estimated 2D position of the virtual object.

### CROSS-REFERENCE TO RELATED APPLICATION

This application claims priority to and the benefit of Korean Patent Application No. 10-2016-0122813, filed on Sep. 26, 2016, the disclosure of which is incorporated herein by reference in its entirety.

### BACKGROUND

### 1. Field of the Invention

The present invention relates to a three-dimensional (3D) transparent display device, and more particularly, to a 3D transparent display device capable of increasing a sense of reality of augmented reality and a method of operating the same.

### 2. Discussion of Related Art

With advancement of electronic technology, various types of display devices have been used in various fields. In particular, research has recently been actively conducted on next-generation display devices such as a transparent display device.

The transparent display device means an apparatus which has a transparent property and on which a background behind the transparent display device is thus directly reflected. Conventionally, a display is manufactured using an opaque semiconductor compound such as silicon (Si) or gallium arsenide (GaAs). However, as various application fields with which existing display panels cannot cope have been developed, efforts have been made to develop new type electronic devices. The transparent display device is one of those developed under the efforts.

The transparent display device includes a transparent oxide semiconductor film and thus has a transparent property. Thus, when the transparent display device is used, a user may view an image provided from the transparent display device together with a real object located behind the transparent display device.

The transparent display device may be conveniently used for various purposes in various environments. For example, when a show window of a shop is implemented as a transparent display device, information regarding products or an advertisement phrase thereof may be displayed on the transparent display device or images of clothes may be displayed on the transparent display device so that mannequins behind the transparent display device may look as if they wear the clothes. Thus, the transparent display device may be used as an augmented reality apparatus for displaying an image of a virtual object with an image of a real object.

As described above, the transparent display device has many advantages owing to the transparent property thereof when compared to existing displaying devices but has problems caused by the transparent property. In particular, since a virtual object and a real object are viewed together, the virtual object displayed on the transparent display device may look to lack a sense of reality.

Furthermore, when an existing transparent display device is used, an image displayed on a transparent display has a different depth from a depth of an image of an object behind the transparent display. Thus, an image of a virtual object displayed on the transparent display may be shown double when a real object is focused, and an image of the real object may be shown double when the virtual object is focused.

Accordingly, when augmented reality is implemented on the basis of an existing transparent display, the effect of augmented reality is low.

### SUMMARY OF THE INVENTION

The present invention is directed to a three-dimensional (3D) transparent display device capable of estimating the position of an image of a virtual object displayed on a display screen on the basis of the positions of both eyes of a user and the position of a real object to control an image of the real object and the image of the virtual object to have the same depth, thereby increasing a sense of reality of augmented reality, and a method of operating the same.

According to an aspect of the present invention, a three-dimensional (3D) transparent display device includes a position obtaining unit configured to obtain information regarding 3D positions of both eyes of a user and a 3D position of a real object; a controller configured to estimate a two-dimensional (2D) position of a virtual object to be displayed on a display screen on the basis of the 3D positions of the both eyes of the user and the 3D position of the real object; and a 3D transparent display panel configured to display an image of the virtual object on the display screen on the basis of the estimated 2D position of the virtual object.

The position obtaining unit may include a first position obtaining unit configured to obtain the information regarding the 3D positions of the both eyes of the user; and a second position obtaining unit configured to obtain the information regarding the 3D position of the real object.

The first and second position obtaining units may calculate 3D coordinates of the 3D positions of the both eyes of the user and 3D coordinates of the 3D position of the real object.

The controller may estimate a 2D position of a left-eye image of the virtual object on the basis of the 3D position of the left eye of the user and the 3D position of the real object, and a 2D position of a right-eye image of the virtual object on the basis of the 3D position of the right eye of the user and the 3D position of the real object.

The controller may calculate 2D coordinates of the 2D positions of the left-eye image and the right-eye image of the virtual object.

The controller may calculate an angle between a horizontal viewpoint of the left eye and a viewpoint at which the real object is viewed, calculate a height of the left-eye image relative to the horizontal viewpoint of the left eye using the angle, a Z-axis coordinate of the 3D transparent display panel, and a Z-axis coordinate of the left eye, and estimate a Y-axis coordinate of the left-eye image of the virtual object using the height of the left-eye image with respect to the left eye and a Y-axis coordinate of the left eye.

The controller may calculate an angle between a horizontal viewpoint of the left eye and a viewpoint at which the real object is viewed, calculate an interval of the left-eye image relative to the horizontal viewpoint of the left eye using the angle, a Z-axis coordinate of the 3D transparent display panel, and a Z-axis coordinate of the left eye, and estimate an X-axis coordinate of the left-eye image of the virtual object using the relative interval of the left-eye image with respect to the left eye and an X-axis coordinate of the left eye.

According to another aspect of the present invention, a method of operating a three-dimensional (3D) transparent display device includes obtaining information regarding 3D positions of both eyes of a user and a 3D position of a real object; estimating a two-dimensional (2D) position on a display screen at which an image of a virtual object is to be displayed on the basis of the 3D positions of the both eyes of the user and the 3D position of the real object; and displaying the image of the virtual object at the estimated 2D position.

The estimating of the 2D position of the virtual object may include estimating a 2D position at which a left-eye image of the virtual object is to be displayed on the basis of the 3D position of the real object and the 3D position of the left eye of the user; and estimating a 2D position at which a right-eye image of the virtual object is to be displayed on the basis of the 3D position of the real object and the 3D position of the right eye of the user.

The displaying of the image of the virtual object may include displaying the left-eye image at the 2D position estimated for the left-eye image, and the right-eye image at the 2D position estimated for the right-eye image.

The estimating of the 2D position at which the left-eye image of the virtual object is to be displayed may include calculating an angle between a horizontal viewpoint of the left eye and a viewpoint at which the real object is viewed, calculating a height of the left-eye image relative to the horizontal viewpoint of the left eye using the angle, a Z-axis coordinate of the 3D transparent display panel, and a Z-axis coordinate of the left eye, and estimating a Y-axis coordinate of the left-eye image of the virtual object using the height of the left-eye image with respect to the left eye and a Y-axis coordinate of the left eye.

The estimating of the 2D position at which the left-eye image of the virtual object is to be displayed may include calculating an angle between a horizontal viewpoint of the left eye and a viewpoint at which the real object is viewed, calculating an interval of the left-eye image relative to the horizontal viewpoint of the left eye using the angle, a Z-axis coordinate of the 3D transparent display panel, and a Z-axis coordinate of the left eye, and estimating an X-axis coordinate of the left-eye image of the virtual object using the relative interval of the left-eye image with respect to the left eye and an X-axis coordinate of the left eye.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating an operation of a three-dimensional (3D) transparent display device according to an embodiment of the present invention;

FIG. 2 is a block diagram illustrating a structure of a 3D transparent display device according to an embodiment of the present invention;

FIGS. 3A and 3B are diagrams illustrating a method of estimating a two-dimensional (2D) position at which an image of a virtual object is to be displayed, performed by a controller, according to an embodiment of the present invention; and

FIG. 4 is a flowchart illustrating an operation of a 3D transparent display device according to an embodiment of the present invention.

### DETAILED DESCRIPTION OF EXEMPLARY EMBODIMENTS

A description of specific structures or functions of embodiments of the present invention set forth herein is simply provided to describe these embodiments. Embodiments of the present invention may be embodied in many different forms and are thus not construed as being limited to those set forth herein.

Various changes may be made in form and details of the present invention and thus exemplary embodiments are illustrated in the drawings and described herein in detail. However, it should be understood that the present invention is not limited thereto and is to cover all modifications, equivalents, and alternatives falling within the scope of the invention.

It will be understood that, although the terms first, second, third, etc., may be used herein to describe various elements, these elements should not be limited by these terms. These terms are only used to distinguish one element from another element. Thus, a first element discussed below could be termed a second element without departing from the teachings of the present invention.

It will be understood that when an element is referred to as being ‘connected to’ or ‘coupled to’ another element, the element can be directly connected or coupled to another element or intervening elements may be present therebetween. In contrast, it will be understood that when an element is referred to as being ‘directly connected to’ or ‘directly coupled to’ another element, there are no intervening elements present. Other expressions describing the relationship between elements, e.g., ‘between’ and ‘right between’ or ‘neighboring to’ and ‘directly neighboring to’ should be understood likewise.

The terminology used herein is for the purpose of describing particular embodiments only and is not intended to be limiting of the invention. As used herein, the singular forms ‘a’, ‘an’ and ‘the’ are intended to include the plural forms as well, unless the context clearly indicates otherwise. It will be further understood that the terms ‘comprise’ and/or ‘comprising,’ when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When an embodiment may be implemented differently, functions or operations described in specific blocks may be performed differently from the order described in a flowchart. For example, two continuous blocks may be performed substantially simultaneously, and may be performed in an opposite order according to a related function or operation.

Hereinafter, a three-dimensional (3D) transparent display device and a method of operating the same according to an embodiment of the present invention will be described in greater detail with reference to the accompanying drawings.

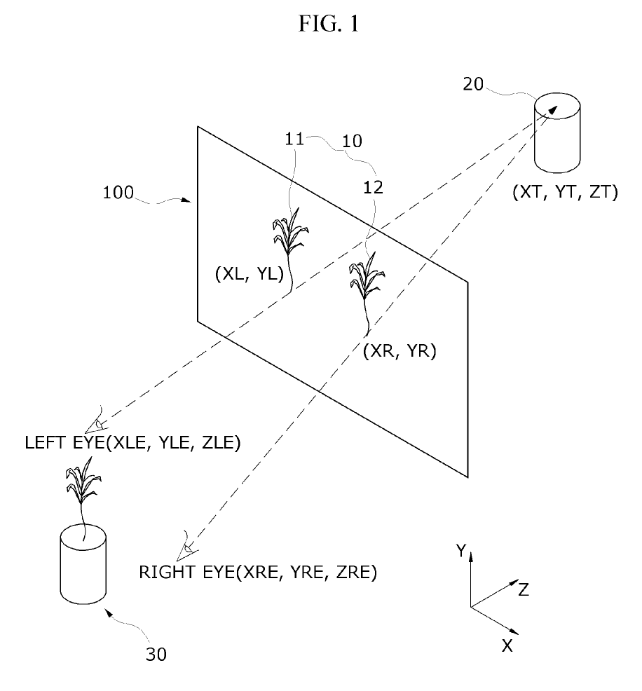

FIG. 1 is a diagram illustrating an operation of a 3D transparent display device 100 according to an embodiment of the present invention.

Referring to FIG. 1, the 3D transparent display device 100 according to an embodiment of the present invention may display an image of a virtual object 10 on a display screen. The display screen of the 3D transparent display device 100 is transparent and thus an image of a real object 20 behind the 3D transparent display device 100 is reflected on the transparent display.

Thus, a user may view an object 30 which is a result of overlapping the image of the virtual object 10 displayed on the display screen with the image of the real object 20 reflected on the display screen.

For example, referring to FIG. 1, when a vase which is the real object 20 is located behind the 3D transparent display device 100 and an image of flower which is the virtual object 10 is displayed on the display screen, the user may view the vase into which the flower is put, i.e., the object 30.

In this case, when the image of the virtual object 10 is displayed on the display screen, the 3D transparent display device 100 separately displays a left-eye image 11 and a right-eye image 12 of the virtual object 10 on the display screen.

Here, the left-eye image 11 of the virtual object 10 is seen only with the user's left eye, and the right-eye image 12 of the virtual object 10 is seen only with the user's right eye.

To this end, the 3D transparent display device 100 obtains information regarding a 3D position of the real object 20, 3D positions of the left and right eyes of the user, estimates 2D positions on the display screen at which the left-eye image 11 and the right-eye image 12 of the virtual object 10 are to be displayed on the basis of the 3D positions, and displays the left-eye image 11 and the right-eye image 12 on the basis of the estimated 2D positions.

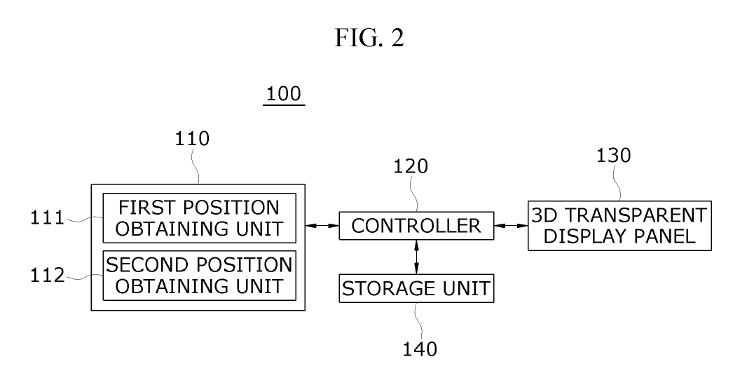

FIG. 2 is a block diagram illustrating a structure of a 3D transparent display device 100 according to an embodiment of the present invention.

The 3D transparent display device 100 according to an embodiment of the present invention will be described in detail with reference to FIGS. 1 and 2 below.

The 3D transparent display device 100 may include a position obtaining unit 110, a controller 120, a 3D transparent display panel 130, and a storage unit 140, but is not limited to these elements illustrated in FIG. 2.

The position obtaining unit 110 obtains information regarding 3D positions of both eyes (a left eye and a right eye) of a user located in a first direction of the 3D transparent display panel 130 (a direction toward a front surface of the 3D transparent display panel 130), and information regarding a 3D position of the real object 20 located in a second direction of the 3D transparent display panel 130 (a direction toward a rear surface of the 3D transparent display panel 130).

To this end, the position obtaining unit 110 may include a first position obtaining unit 111 which obtains the information regarding the 3D positions of the both eyes of the user located in the first direction of the 3D transparent display panel 130, and a second position obtaining unit 112 which obtains the information regarding the 3D position of the real object 20 located in the second direction of the 3D transparent display panel 130.

The first and second position obtaining units 111 and 112 may be arranged at positions appropriate for effectively performing a function according to an installation purpose, and are not limited to specific positions.

For example, the first and second position obtaining units 111 and 112 may be arranged on the 3D transparent display panel 130. In this case, the first position obtaining unit 111 may be arranged on the front surface of the 3D transparent display panel 130 and the second position obtaining unit 112 may be arranged on the rear surface of the 3D transparent display panel 130.

The first position obtaining unit 111 may obtain the information regarding the positions of the both eyes of the user by calculating 3D coordinates of the positions of the both eyes of the user in a 3D space.

That is, the first position obtaining unit 111 may calculate 3D coordinates (XLE, YLE, ZLE) of the position of the left eye in the 3D space, and 3D coordinates (XRE, YRE, ZRE) of the right eye in the 3D space.

Here, XLE, YLE, and ZLE respectively represent an X-axis coordinate, a Y-axis coordinate, and a Z-axis coordinate of the left eye, and XRE, YRE, and ZRE respectively represent an X-axis coordinate, a Y-axis coordinate, and a Z-axis coordinate of the right eye.

For example, the first position obtaining unit 111 may be embodied as a 3D camera using a plurality of imaging units to obtain the information regarding the 3D positions of the both eyes of the user, and obtain the information regarding the 3D positions of the both eyes of the user by triangulation, but a method of obtaining the information regarding the positions of the both eyes of the user in the 3D space is not limited thereto.

The second position obtaining unit 112 may obtain the information regarding the position of the real object by calculating 3D coordinates of the position of the real object 20 in the 3D space.

That is, the second position obtaining unit 112 may calculate 3D coordinates (XT, YT, ZT) of the position of the real object 20. Here, XT, YT, and ZT respectively represent an X-axis coordinate, a Y-axis coordinate, and a Z-axis coordinate of the real object 20.

For example, the second position obtaining unit 112 may be embodied as a 3D camera using a plurality of imaging units and obtain the information regarding the position of the real object 20 by triangulation, but a method of obtaining the information regarding the position of the real object 20 in the 3D space is not limited thereto.

The controller 120 may include at least one processor, and estimate 2D positions on a display screen at which the left-eye image 11 and the right-eye image 12 of the virtual object 10 are to be displayed on the basis of the information obtained by the position obtaining unit 110.

That is, the controller 120 may estimate 2D positions of the left-eye image 11 and the right-eye image 12 of the virtual object 10 on the basis of the 3D positions of the both eyes of the user and the 3D position of the real object 20.

Here, the controller 120 may estimate the 2D positions of the left-eye image 11 and the right-eye image 12, so that the left-eye image 11 of the virtual object 10 may be seen only with the user's left eye and the right-eye image 12 of the virtual object 10 may be seen only with the user's right eye.

To this end, the controller 120 may estimate the 2D position of the left-eye image 11 on the basis of the 3D position of the real object 20 and the 3D position of the left eye, and estimate the 2D position of the right-eye image 12 on the basis of the 3D position of the real object 20 and the 3D position of the right eye.

In this case, the controller 120 may calculate 2D coordinates (XL, YL) of the position of the left-eye image 11 and 2D coordinates (XR, YR) of the position of the right-eye image 12. Here, XL and YL respectively represent an X-axis coordinate and a Y-axis coordinate of the left-eye image 11, and XR and YR respectively represent an X-axis coordinate and a Y-axis coordinate of the right-eye image 12.

Hereinafter, the 2D coordinates of the left-eye image 11 will be referred to as left-eye image coordinates' and the 2D coordinates of the right-eye image 12 will be referred to as ‘right-eye image coordinates’.

In particular, the left-eye image coordinates and the right-eye image coordinates estimated by the controller 120 may be coordinates of a center of the left-eye image 11 and coordinates of a center of the right-eye image 12.

A method of estimating a 2D position of a left-eye image (or a right-eye image) of a virtual object on the basis of a 3D position of a real object and a 3D position of an left eye (or a right eye), performed by the controller 120, will be described with reference to the accompanying drawings below.

The 3D transparent display panel 130 displays the virtual object 10 on the display screen, and is formed to be transparent such that an image of the real object 20 behind the 3D transparent display panel 130 is reflected on the 3D transparent display panel 130.

In this case, the 3D transparent display panel 130 is configured to display the virtual object 10 such that two images of the virtual object 10, i.e., the left-eye image 11 and the right-eye image 12, are displayed.

In particular, the 3D transparent display panel 130 displays the left-eye image 11 and the right-eye image 12 on the basis of the coordinates estimated by the controller 120.

That is, the 3D transparent display panel 130 displays the left-eye image 11 at the left-eye image coordinates estimated by the controller 120 and the right-eye image 12 at the right-eye image coordinates estimated by the controller 120.

For example, the 3D transparent display panel 130 may be embodied as one of various types of display panels, such as a transparent liquid crystal display (LCD) type display panel, a transparent thin-film electroluminescent (TFEL) panel type display panel, a transparent organic light-emitting diode (OLED) type display panel, and a transmission type display panel.

The storage unit 140 may be embodied as at least one memory, and store various data or an algorithm needed to operate the transparent display device 100. Furthermore, the storage unit 140 may store a control program and applications for controlling the transparent display device 100 or the controller 120.

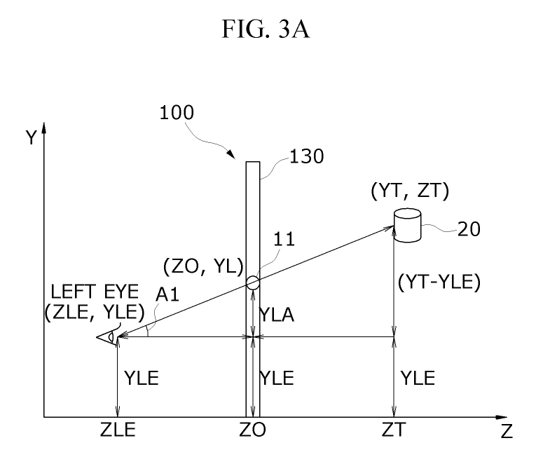

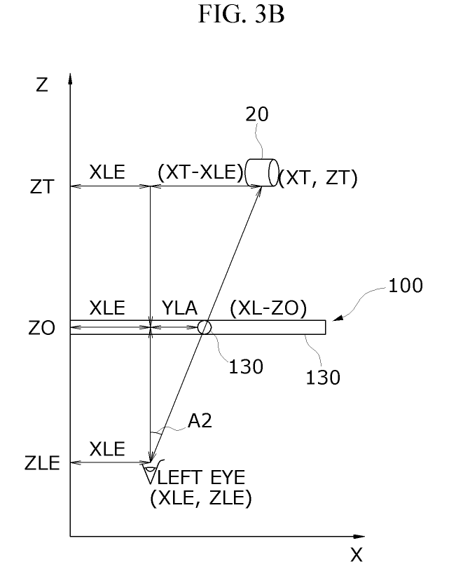

FIGS. 3A and 3B are diagrams illustrating a method of estimating a 2D position at which an image of a virtual object is to be displayed, performed by a controller, according to an embodiment of the present invention.

FIG. 3A is a diagram two-dimensionally illustrating the Y-axis and the Z-axis of the diagram of FIG. 1 to describe a method of estimating a Y-axis coordinate of a 2D position at which an image of a virtual object (not shown) is to be displayed. FIG. 3B is a diagram two-dimensionally illustrating the X-axis and the Z-axis of the diagram of FIG. 1 to describe a method of estimating an X-axis coordinate of the 2D position at which the image of the virtual object is to be displayed.

FIGS. 3A and 3B are diagrams illustrating a method of estimating a 2D position of a left-eye image of the virtual object on the basis of a 3D position of a real object 20 and a 3D position of a left eye. The method of estimating the 2D position of the left-eye image of the virtual object to be described below may also apply to estimating a 2D position of a right-eye image of the virtual object. Thus, a description of the estimation of the 2D position of the right-eye image of the virtual object will be omitted here.

First, a method of estimating a Y-axis coordinate of a 2D position at which an image of the virtual object is to be displayed will be described with reference to FIG. 3A.

In FIG. 3A, Zo represents information known as a fixed distance of a 3D transparent display panel 130, and information regarding a Z-axis coordinate ZLE and a Y-axis coordinate YLE of the left eye and a Z-axis coordinate ZT and a Y-axis coordinate YT of the real object 20 are obtained by the first and second position obtaining units 111 and 112 prior to the estimation of the 2D position of the virtual object 30.

Thus, the controller 120 estimates a Y-axis coordinate YL of the left-eye image of the virtual object by applying already-known values, i.e., the Z-axis coordinate Zo of the 3D transparent display panel 130, the Z and Y axis coordinates ZLE and YLE of the left eye, and the Z and Y axis coordinates ZT and YT of the real object 20, to Equation 1 below.

$$A 1 = {tan}^{- 1} ( \frac{\vert YT - YLE \vert}{ZT - ZLE} ) \\ tan ( A 1 ) = \frac{YLA}{ZO - ZLE} \\ YLA = ( ZO - ZLE ) \times tan ( A 1 ) \\ YL = YLA + YLE , when object on Y - axis is above eye \\ YL = YLE - YLA , when object on Y - axis is below eye \qquad [ Equation 1 ]$$

That is, the controller 120 calculates an angle A1 between a horizontal viewpoint of the left eye and a viewpoint from which the real object 20 is viewed, and calculates a height YLA of the left-eye image relative to the horizontal viewpoint of the left eye using the angle A1, the Z-axis coordinate Zo of the 3D transparent display panel 130, and the Z-axis coordinate ZLE of the left eye.

Furthermore, the controller 120 estimates the Y-axis coordinate YL of the left-eye image of the virtual object using the height YLA of the left-eye image with respect to the left eye and the Y-axis coordinate YLE of the left eye.

Next, a method of estimating an X-axis coordinate of the 2D position at which the image of the virtual object is to be displayed will be described with reference to FIG. 3B below.

In FIG. 3B, Zo represents the information known as the fixed distance of the 3D transparent display panel 130, and information regarding an X-axis coordinate XLE and a Z-axis coordinate ZLE of the left eye and an X-axis coordinate XT and a Z-axis coordinate ZT of the real object 20 are obtained by the first and second position obtaining units 111 and 112 prior to the estimation of the 2D position of the virtual object 30.

Thus, the controller 120 estimates an X-axis coordinate XL of the left-eye image of the virtual object by applying the already-known values, i.e., the Z-axis coordinate Zo of the 3D transparent display panel 130, the X and Z axis coordinates XLE and ZLE of the left eye, and the X and Z axis coordinates XT and ZT of the real object 20, to Equation 2 below.

$$A 2 = {tan}^{- 1} ( \frac{\vert XT - XLE \vert}{ZT - XLE} ) \\ tan ( A 2 ) = \frac{XLA}{ZO - ZLE} \\ XLA = ( ZO - ZLE ) \times tan ( A 2 ) \\ XL = XLA + XLE , when object on X - axis is located at right side of eye \\ XL = XLE - XLA , when object on X - axis is located at left side of eye \qquad [ Equation 2 ]$$

That is, the controller 120 calculates an angle A2 between a horizontal viewpoint of the left eye and a viewpoint from which the real object 20 is viewed, and calculates an interval XLA of the left-eye image relative to the horizontal viewpoint of the left eye using the angle A2, the Z-axis coordinate Zo of the 3D transparent display panel 130, and the Z-axis coordinate ZLE of the left eye.

Furthermore, the controller 120 estimates the X-axis coordinate XL of the left-eye image of the virtual object using the relative interval XLA of the left-eye image with respect to the left eye and the X-axis coordinate XLE of the left eye.

A structure and operation of a transparent display device according to an embodiment of the present invention have been described above in detail. An operation of a transparent display device according to an embodiment of the present invention will be described in more detail below.

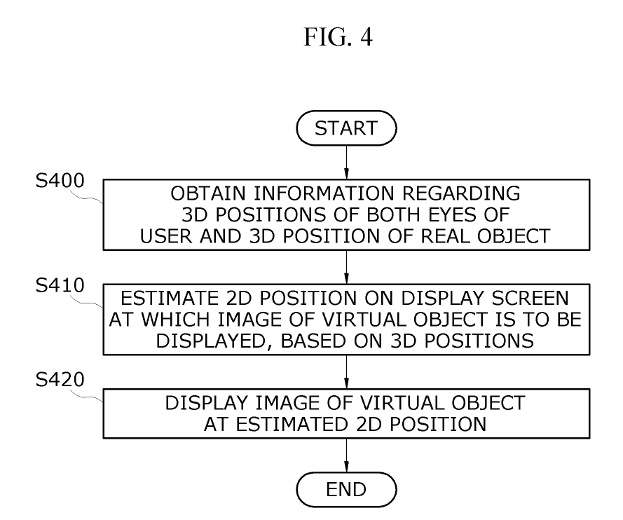

FIG. 4 is a flowchart illustrating an operation of a 3D transparent display device according to an embodiment of the present invention.

The operation of the 3D transparent display device illustrated in FIG. 4 may apply to the transparent display device 100 described above with reference to FIGS. 1 to 3. The position obtaining unit 110 obtains information regarding 3D positions of both eyes of a user and a 3D position of the real object 20 (operation S400).

In operation S400, 3D coordinates of the 3D positions of the both eyes of the user and 3D coordinates of the 3D position of the real object 20 may be calculated by the position obtaining unit 110.

After operation S400, the controller 120 estimates a 2D position on the display screen at which the virtual object 10 is to be displayed on the basis of the information regarding the 3D positions obtained in operation S400 (operation S410).

In operation S410, the virtual object 10 is divided into the left-eye image 11 and the right-eye image 12. The estimation of the 2D position for the virtual object 10 includes estimating a 2D position for the left-eye image 11 and estimating a 2D position for the right-eye image 12.

Furthermore, in operation S410, the 2D position for the left-eye image 11 is estimated on the basis of the 3D position of the real object 20 and a 3D position of the left eye of the user.

Similarly, in operation S410, the 2D position for the right-eye image 12 is estimated on the basis of the 3D position of the real object 20 and a 3D position of the right eye of the user.

In addition, in operation S410, 2D coordinates of the 2D position for the virtual object 10 may be calculated by the controller 120.

Estimation of the 2D position for the virtual object 10 is as described above with reference to FIGS. 3A and 3B and a detailed description thereof is omitted here.

After operation S410, the 3D transparent display panel 130 displays an image of the virtual object 10 at the 2D position estimated in operation S410 while projecting an image of the real object 20 (operation S420).

In this case, the displaying of the virtual object 10 in operation S420 may be performed by displaying the left-eye image 11 and the right-eye image 12 of the virtual object 10.

In detail, the displaying of the virtual object 10 in operation S420 may be performed by displaying the left-eye image at the 2D position for the left-eye image 11 estimated in operation S410 and the right-eye image at the 2D position for the right-eye image 12 estimated in operation S410.

As described above, a 3D transparent display device according to an embodiment of the present invention may estimate a position of a virtual object to be displayed on a display screen on the basis of the positions of both eyes of a user and the position of a real object.

In particular, the 3D transparent display device according to an embodiment of the present invention may estimate positions of a left-eye image and a right-eye image of the virtual object and respectively display the left-eye image and the right-eye image at the positions.

Thus, with use of the 3D transparent display device according to an embodiment of the present invention, images of a real object and a virtual object may be controlled to have the same depth, so that an effect of causing the real object and the virtual object to look as if they overlapped with each other may be obtained.

Accordingly, a sense of reality of the image of the virtual object displayed on the transparent display device may be increased. That is, a sense of reality of augmented reality may be increased.

While a transparent display device and a method of operating the same according to embodiments of the present invention have been described above, the scope of the present invention is not limited thereto and it would be obvious to those of ordinary skill in the art that these embodiments are to cover all alternatives, modifications, and equivalents falling within the scope of the invention.

Accordingly, the embodiments described herein and the appended drawings are not intended to restrict the scope of the present invention and are only used to describe the present invention. Thus, the scope of the present invention is not limited by these embodiments and the drawings. Accordingly, it is intended that the present invention covers all such modifications provided they come within the scope of the appended claims and their equivalents.

What is claimed is:

1. A three-dimensional (3D) transparent display device comprising:
a position obtaining unit configured to obtain information regarding 3D positions of both eyes of a user and a 3D position of a real object;
a controller configured to estimate a two-dimensional (2D) position on a display screen at which an image of a virtual object is to be displayed on the basis of the 3D positions of the both eyes of the user and the 3D position of the real object; and
a 3D transparent display panel configured to display the image of the virtual object on the display screen on the basis of the estimated 2D position of the virtual object.

2. The apparatus of claim 1, wherein the position obtaining unit comprises:
a first position obtaining unit configured to obtain the information regarding the 3D positions of the both eyes of the user; and
a second position obtaining unit configured to obtain the information regarding the 3D position of the real object.

3. The apparatus of claim 2, wherein the first and second position obtaining units calculate 3D coordinates of the 3D positions of the both eyes of the user and 3D coordinates of the 3D position of the real object.

4. The apparatus of claim 1, wherein the controller estimates a 2D position of a left-eye image of the virtual object on the basis of the 3D position of the left eye of the user and the 3D position of the real object, and a 2D position of a right-eye image of the virtual object on the basis of the 3D position of the right eye of the user and the 3D position of the real object.

5. The apparatus of claim 4, wherein the controller calculates 2D coordinates of the 2D positions of the left-eye image and the right-eye image of the virtual object.

6. The apparatus of claim 4, wherein the controller calculates an angle between a horizontal viewpoint of the left eye and a viewpoint at which the real object is viewed, calculates a height of the left-eye image relative to the horizontal viewpoint of the left eye using the angle, a Z-axis coordinate of the 3D transparent display panel, and a Z-axis coordinate of the left eye, and estimates a Y-axis coordinate of the left-eye image of the virtual object using the height of the left-eye image with respect to the left eye and a Y-axis coordinate of the left eye.

7. The apparatus of claim 4, wherein the controller calculates an angle between a horizontal viewpoint of the left eye and a viewpoint at which the real object is viewed, calculates an interval of the left-eye image relative to the horizontal viewpoint of the left eye using the angle, a Z-axis coordinate of the 3D transparent display panel, and a Z-axis coordinate of the left eye, and estimates an X-axis coordinate of the left-eye image of the virtual object using the relative interval of the left-eye image with respect to the left eye and an X-axis coordinate of the left eye.

8. A method of operating a three-dimensional (3D) transparent display device, the method comprising:
obtaining information regarding 3D positions of both eyes of a user and a 3D position of a real object;
estimating a two-dimensional (2D) position on a display screen at which an image of a virtual object is to be displayed on the basis of the 3D positions of the both eyes of the user and the 3D position of the real object; and
displaying the image of the virtual object at the estimated 2D position.

9. The method of claim 8, wherein the estimating of the 2D position of the virtual object comprises:
estimating a 2D position at which a left-eye image of the virtual object is to be displayed on the basis of the 3D position of the real object and the 3D position of the left eye of the user; and
estimating a 2D position at which a right-eye image of the virtual object is to be displayed on the basis of the 3D position of the real object and the 3D position of the right eye of the user.

10. The method of claim 9, wherein the displaying of the image of the virtual object comprises displaying the left-eye image at the 2D position estimated for the left-eye image, and the right-eye image at the 2D position estimated for the right-eye image.

11. The method of claim 9, wherein the estimating of the 2D position at which the left-eye image of the virtual object is to be displayed comprises calculating an angle between a horizontal viewpoint of the left eye and a viewpoint at which the real object is viewed, calculating a height of the left-eye image relative to the horizontal viewpoint of the left eye using the angle, a Z-axis coordinate of the 3D transparent display panel, and a Z-axis coordinate of the left eye, and estimating a Y-axis coordinate of the left-eye image of the virtual object using the height of the left-eye image with respect to the left eye and a Y-axis coordinate of the left eye.

12. The method of claim 9, wherein the estimating of the 2D position at which the left-eye image of the virtual object is to be displayed comprises calculating an angle between a horizontal viewpoint of the left eye and a viewpoint at which the real object is viewed, calculating an interval of the left-eye image relative to the horizontal viewpoint of the left eye using the angle, a Z-axis coordinate of the 3D transparent display panel, and a Z-axis coordinate of the left eye, and estimating an X-axis coordinate of the left-eye image of the virtual object using the relative interval of the left-eye image with respect to the left eye and an X-axis coordinate of the left eye.
